(19) United States
(12) Patent Application Publication
(10) Pub. No.: US 2025/0209409 A1
(43) Pub. Date: Jun. 26, 2025

(54) TRANSFER DEVICE CONTROL SYSTEM

(71) Applicant: Samsung Display Co., LTD., Yongin-si (KR)

(72) Inventors: Dae Geon KIM, Yongin-si (KR); Ki Jin CHO, Yongin-si (KR); Jae Geun CHO, Yongin-si (KR); Ho Yun LEE, Yongin-si (KR)

(73) Assignee: Samsung Display Co., LTD., Yongin-si (KR)

(21) Appl. No.: 18/905,926

(22) Filed: Oct. 3, 2024

(30) Foreign Application Priority Data
Dec. 22, 2023 (KR) 10-2023-0190003

(51) Int. Cl. G06Q 10/08

(52) U.S. Cl. CPC G06Q 10/08

(57) ABSTRACT

A transfer device control system includes a linear transfer device including transfer modules of a linear motion guide type, a slave computer setting a transfer path for carriers or logistics by checking an arrangement structure of the transfer modules and controlling a transfer operation of the logistics for each of the transfer modules in real time by checking an operation status of each of the transfer modules, and a master facility server supplying arrangement information of the transfer modules and logistics schedule information for each logistics transfer period to the slave computer.

### CROSS-REFERENCE TO RELATED APPLICATION

This application claims priority to and the benefits of Korean Patent Application No. 10-2023 -0190003 under 35 U.S.C. § 119, filed on Dec. 22, 2023 in the Korean Intellectual Property Office, the contents of which are hereby incorporated by reference in its entirety.

### BACKGROUND

### 1. Technical Field

The disclosure relates to a transfer device control system.

### 2. Description of the Related Art

The importance of a display device is increasing with the development of multimedia. Accordingly, various types of display devices such as an organic light emitting display (OLED) or a liquid crystal display (LCD) are being used.

The display device includes a display panel such as a light emitting display panel or a liquid crystal display panel as a device for displaying images. Among them, the light emitting display panel may include a light emitting diode (LED). Examples of light emitting diode include an organic light emitting diode that uses an organic material as a fluorescent material, or an inorganic light emitting diode that uses an inorganic material as a fluorescent material.

In case that manufacturing a light emitting diode display panel using the inorganic or organic light emitting diode as the light emitting diode, various logistics are transferred using transfer devices such as a linear motion guide device. For example, in case that manufacturing the display panel, multiple transfer devices are used to transfer a carrier containing photoresist, organic or inorganic materials, etc., and a transparent insulating substrate to various manufacturing devices.

Since conventional transfer devices control the operation of the transfer devices only through logic preset in the facility operation server or master control device of the transfer devices, there is a problem that a logistics transfer route of the transfer devices cannot be changed or transfer devices cannot be added. There is also a problem that changing individual control logic of the transfer devices is complicated.

### SUMMARY

Aspects of the disclosure provide a transfer device control system capable of readily controlling multiple transfer devices using a computer, a slave control board, or the like according to a logistics transfer schedule, a transfer node, and a transfer section.

Aspects of the disclosure also provide a transfer device control system capable of readily changing the transfer route and control logic of transfer devices by selecting preset control functions and programs to control driving operations such as a logistics transfer direction and a transfer velocity of the transfer devices.

However, aspects of the disclosure are not restricted to those set forth herein. The above and other aspects of the disclosure will become more apparent to one of ordinary skill in the art to which the disclosure pertains by referencing the detailed description of the disclosure given below.

According to an embodiment of the disclosure, a transfer device control system may comprise a linear transfer device including first to n-th transfer modules of a linear motion guide type, wherein n is a positive integer, a slave computer setting a transfer path for carriers or logistics by checking an arrangement structure of the first to n-th transfer modules, and controlling a transfer operation of the logistics for each of the first to n-th transfer modules in real time by checking an operation status of each of the first to n-th transfer modules, and a master facility server supplying arrangement information of the first to n-th transfer modules and logistics schedule information for each logistics transfer period to the slave computer.

In an embodiment, the master facility server may include a logistics schedule management unit supplying the logistics schedule information for each logistics transfer period input or upgraded in real time by a manager to the slave computer, and a transfer node management unit supplying the arrangement information of the first to n-th transfer modules arranged and connected in a series structure, a parallel structure, or a mesh structure in which serial and parallel structures are combined, to the slave computer.

In an embodiment, the master facility server further may include a transfer path management unit calculating transfer paths through which the logistics are transferred according to the arrangement information of the first to n-th transfer modules and supplying information on the calculated transfer paths to the slave computer, and the transfer node management unit checks arrangement position information of transfer nodes where at least three or more transfer modules are connected or branched according to the arrangement information of the first to n-th transfer modules and supplies the arrangement position information to the slave computer.

In an embodiment, the slave computer may include a module control unit sequentially calculating first to n-th transfer paths through which the logistics are transferred by reflecting the arrangement information of the first to n-th transfer modules and arrangement position information of transfer nodes, and setting driving characteristics of each of the first to n-th transfer modules using at least one command function among first to n-th command functions, a first command function setting unit setting and storing first command functions including first instructions and supplying the first command functions to the module control unit, a second command function setting unit setting and storing second command functions including second instructions and supplying the second command functions to the module control unit, and an n-th command function setting unit setting and storing third command functions including third instructions and supplying the third command functions to the module control unit.

In an embodiment, the module control unit may include a transfer path setting unit detecting the arrangement position information of the transfer nodes where at least three or more transfer modules are connected or branched by checking the arrangement information of the first to n-th transfer modules in real time and sequentially calculating first to n-th transfer sections and first to n-th transfer paths through which the logistics are transferred by reflecting the arrangement information of the first to n-th transfer modules and the arrangement position information of the first to n-th transfer nodes, and a command function selection unit receiving and checking status information of the first to n-th transfer modules included in the first to n-th transfer paths by sequentially transmitting the first command functions to the transfer modules included in the first to n-th transfer paths, and setting driving characteristics including driving timing, logistics transfer direction, and logistics transfer velocity of each of the first to n-th transfer modules included in the first to n-th transfer paths by sequentially transmitting the second command functions to the first to n-th transfer modules included in the first to n-th transfer paths.

In an embodiment, the command function selection unit may set driving characteristics including the driving timing, change direction, direction change operation, direction change velocity, and the logistics transfer velocity of each of the first to n-th transfer modules disposed at the transfer nodes by transmitting the third command functions to each of the first to n-th transfer modules disposed at the transfer nodes among the first to n-th transfer modules included in the first to n-th transfer paths.

In an embodiment, the first command function setting unit may store first command functions including a status information check instruction requesting to transmit status information for each of the first to n-th transfer modules, a driving standby check instruction requesting to transmit driving standby status information for each of the first to n-th transfer modules and a transfer check instruction requesting to transmit logistics transfer completion status information for each of the first to n-th transfer modules and transmit the first command functions to the module control unit according to selection of the module control unit.

In an embodiment, the second command function setting unit may store second command functions including a transfer direction setting instruction that sets a transfer direction of each of the first to n-th transfer modules included in the first to n-th transfer paths, a transfer velocity and transfer position setting instruction of each of the first to n-th transfer modules, and a transfer start and end instruction of each of the first to n-th transfer modules and transmit the second command functions to the module control unit according to selection of the module control unit.

In an embodiment, the n-th command function setting unit may store third command functions including a direction change instruction, a change direction setting instruction, a direction change velocity setting instruction, a direction change and transfer position instruction, and a direction change start and end instruction for each of the transfer modules disposed at the transfer nodes among the transfer modules included in the first to n-th transfer paths and transmit the third command functions to the module control unit according to selection of the module control unit.

In an embodiment, each of the first to n-th transfer modules may include at least one linear transfer core module transferring and delivering the carriers or the logistics along a preset path according to an arrangement direction, an input/output communication unit transmitting status information of the at least one linear transfer core module to the slave computer in response to first command functions input from the slave computer, receiving second command functions input from the slave computer, and storing and sharing the received second command functions, and a module driving control unit setting logistics transfer and delivery positions for each of the at least one linear transfer core module in response to the second command functions including second instructions, and controlling driving characteristics including logistics transfer direction and logistics transfer velocity in real time.

According to an embodiment of the disclosure, a transfer device control system may comprise a linear transfer device including first to n-th transfer modules of a linear motion guide type, and n is a positive integer, a slave computer setting a transfer path for carriers or logistics by checking an arrangement structure of the first to n-th transfer modules, and controlling a transfer operation of the logistics for each of the first to n-th transfer modules in real time by checking an operation status of each of the first to n-th transfer modules, and a master facility server supplying arrangement information of the first to n-th transfer modules and logistics schedule information for each logistics transfer period to the slave computer, wherein the slave computer sequentially calculates transfer paths through which the logistics are transferred according to the arrangement information of the first to n-th transfer modules and controls a logistics transfer operation of the first to n-th transfer modules for each of the transfer paths.

In an embodiment, the master facility server may include a logistics schedule management unit supplying the logistics schedule information for each logistics transfer period input or upgraded in real time by a manager to the slave computer, and a transfer node management unit supplying the arrangement information of the first to n-th transfer modules arranged and connected in a series structure, a parallel structure, or a mesh structure in which serial and parallel structures are combined, to the slave computer.

In an embodiment, the slave computer may include a module control unit sequentially calculating first to n-th transfer paths through which the logistics are transferred by reflecting the arrangement information of the first to n-th transfer modules and arrangement position information of transfer nodes and setting driving characteristics of each of the first to n-th transfer modules using at least one command function among first to n-th command functions, a first command function setting unit setting and storing first command functions including first instructions and supplying the first command functions to the module control unit, a second command function setting unit setting and storing second command functions including second instructions and supplying the second command functions to the module control unit, and an n-th command function setting unit setting and storing third command functions including third instructions and supplying the third command functions to the module control unit.

In an embodiment, the module control unit may include a transfer path setting unit detecting arrangement position information of the transfer nodes where at least three or more transfer modules are connected or branched by checking the arrangement information of the first to n-th transfer modules in real time and sequentially calculating first to n-th transfer sections and first to n-th transfer paths through which the logistics are transferred by reflecting the arrangement information of the first to n-th transfer modules and the arrangement position information of the transfer nodes, and a command function selection unit receiving and checking status information of the first to n-th transfer modules included in the first to n-th transfer paths by sequentially transmitting the first command functions to the first to n-th transfer modules included in the first to n-th transfer paths and setting driving characteristics including driving timing, logistics transfer direction, and logistics transfer velocity of each of the first to n-th transfer modules included in the first to n-th transfer paths by sequentially transmitting the second command functions to the first to n-th transfer modules included in the first to n-th transfer paths.

In an embodiment, each of the first to n-th transfer modules may include at least one linear transfer core module transferring and delivering the carriers or the logistics along a preset path according to an arrangement direction, an input/output communication unit transmitting status information of the at least one linear transfer core module to the slave computer in response to first command functions input from the slave computer, receiving second command functions input from the slave computer, and storing and sharing the received second command functions, and a module driving control unit setting logistics transfer and delivery positions for each of the at least one linear transfer core module in response to the second command functions including second instructions, and controlling driving characteristics including logistics transfer direction and logistics transfer velocity in real time.

According to embodiments, the operation of the transfer devices may be readily controlled using a computer or slave control board by selecting preset control functions or programs according to the logistics movement route or transfer section and controlling the transfer devices with the selected control functions or programs.

Logistics transfer efficiency and management efficiency of manufacturing devices may be improved by readily controlling the transfer operation of transfer devices according to the logistics transfer schedule, transfer node, and transfer section even if the transfer devices are added or the logistics transfer routes of the transfer devices are changed.

However, the effects of the embodiments are not restricted to the one set forth herein. The above and other effects of the embodiments will become more apparent to one of daily skill in the art to which the embodiments pertain by referencing the claims.

### BRIEF DESCRIPTION OF THE DRAWINGS

The above and other aspects and features of the disclosure will become more apparent by describing in detail embodiments thereof with reference to the attached drawings, in which:

FIG. 1 is a schematic perspective view schematically illustrating a transfer device control system according to an embodiment of the disclosure;

FIG. 2 is a block diagram specifically illustrating the transfer device control system of FIG. 1;

FIG. 3 is a block diagram illustrating a process of a logic control processing of a master facility server illustrated in FIG. 2;

FIG. 4 is a block diagram illustrating a process of a logic control processing of a slave computer illustrated in FIG. 2;

FIG. 5 is a block diagram illustrating an example of logic control program and function settings of the slave computer illustrated in FIG. 4;

FIG. 6 is a block diagram illustrating an example of logic control program and function settings of the slave computer illustrated in FIG. 4; and

FIG. 7 is a waveform diagram illustrating the timing of transmission and reception of control signals and data transmitted and received between the slave computer and the transfer devices.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the disclosure. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

Each of the features of the various embodiments of the disclosure may be combined or combined with each other, in part or in whole, and technically various interlocking and driving are possible. Each embodiment may be implemented independently of each other or may be implemented together in an association.

Hereinafter, specific embodiments will be described with reference to the accompanying drawings.

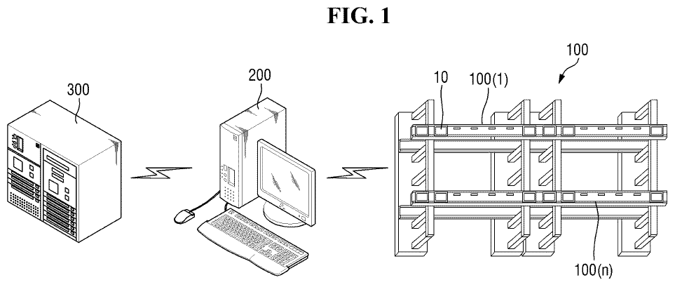

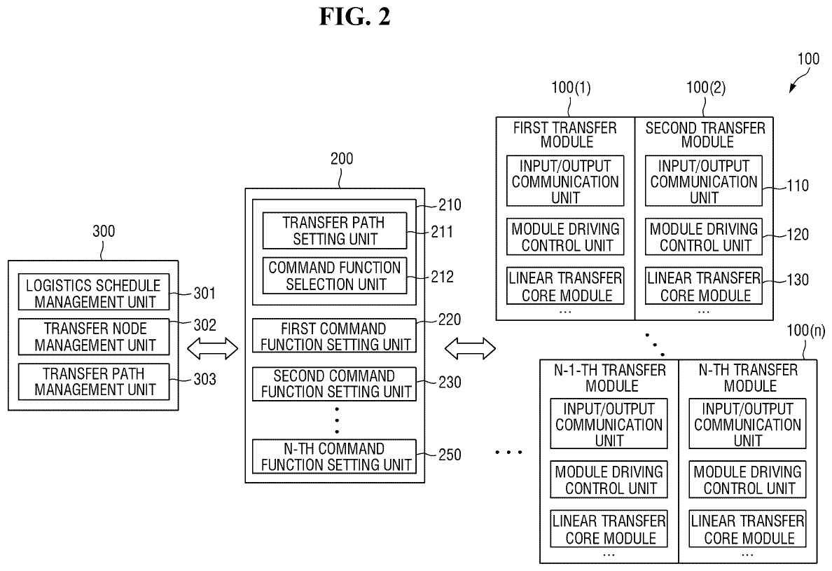

FIG. 1 is a schematic perspective view schematically illustrating a transfer device control system according to an embodiment of the disclosure. FIG. 2 is a block diagram specifically illustrating the transfer device control system of FIG. 1.

Referring to FIGS. 1 and 2, a transfer device control system according to an embodiment may include a linear transfer device 100, a slave computer 200, and a master facility server 300.

The linear transfer device 100 may include transfer modules formed of a linear motion guide type, for example, first to n-th transfer modules 100(1) to 100(n). Here, n is a positive integer.

The first to n-th transfer modules 100(1) to 100(n) may be respectively arranged and connected in a series structure, a parallel structure, or a mesh structure in which series and parallel structures are combined. In case that the first to n-th transfer modules 100(1) to 100(n) are connected in the parallel structure or mesh structure, transfer nodes at which three or more transfer modules among the first to n-th transfer modules 100(1) to 100(n) are connected or branched may be formed.

Each of the first to n-th transfer modules 100(1) to 100(n) may include an input/output communication unit 110, a module driving control unit 120, and a linear transfer core module 130.

At least one linear transfer core module 130 may transfer and deliver logistics such as a carrier 10 along a preset path according to an arrangement direction of each linear transfer core module 130. Each linear transfer core module 130 may include a loading plate on which logistics such as the carrier 10 are seated, a coiled rail forming a transfer axis of the loading plate, a conveyor that transfers the loading plate, and a driving motor applying power to the coiled rail and the conveyor.

The input/output communication unit 110 may include at least one short-distance wired/wireless communication module that performs Bluetooth, Wi-Fi, or ZigBee communication or a long-distance wired/wireless communication module that performs long-distance communication such as LTE or 5G and a microprocessor.

In case that first command functions including first instructions are input from the slave computer 200, the input/output communication unit 110 transmits status information of each linear transfer core module 130 to the slave computer 200. The input/output communication unit 110 receives second command functions including second instructions from the slave computer 200, stores the second command functions until the next second command functions are received, and shares the second command functions with the module driving control unit 120.

The module driving control unit 120 may set a logistics transfer and delivery position for each linear transfer core module 130 in response to the second instructions of the second command functions received through the input/output communication unit 110. The module driving control unit 120 may control driving characteristics such as a logistics transfer direction and a logistics transfer velocity for each linear transfer core module 130 in real time. Specifically, the module driving control unit 120 may repeatedly control the driving timing and driving velocity for each driving motor of the linear transfer core module 130 in response to the second instructions of the second command functions.

The master facility server 300 may store arrangement information of the first to n-th transfer modules 100(1) to 100(n) and logistics schedule information for each logistics transfer period that are upgraded by a manager. The master facility server 300 may supply the arrangement information of the first to n-th transfer modules 100(1) to 100(n) and the logistics schedule information for each logistics transfer period to the slave computer 200.

Specifically, the master facility server 300 may supply arrangement information of the first to n-th transfer modules 100(1) to 100(n) arranged and connected in the series structure, the parallel structure, or the mesh structure in which the series and parallel structures are combined, etc. to the slave computer 200. The master facility server 300 may check position information of transfer nodes at which at least three or more transfer modules are connected or branched according to the arrangement information of the first to n-th transfer modules 100(1) to 100(n), for example, arrangement position information of the transfer nodes, and supply the position information to the slave computer 200.

The master facility server 300 may calculate transfer paths through which logistics such as the carrier 10 may be transferred according to the arrangement information of the first to n-th transfer modules 100(1) to 100(n) and supply the calculated transfer path information to the slave computer 200. Thereafter, the master facility server 300 may supply logistics schedule information for each logistics transfer period, which is input or upgraded in real time by the manager, to the slave computer 200.

Referring to FIG. 2, the master facility server 300 may include a logistics schedule management unit 301, a transfer node management unit 302, and a transfer path management unit 303.

The logistics schedule management unit 301 may supply logistics schedule information for each logistics transfer period, which is input or upgraded in real time by the manager, to the slave computer 200. The logistics schedule management unit 301 may check a logistics transfer quantity in real time and divide the logistics transfer periods according to the logistics transfer quantity. The logistics schedule management unit 301 may sequentially check the logistics transfer paths, for example, the number of logistics transfer paths, transfer position, and transfer distance, and distribute and set the logistics transfer schedule for each logistics transfer period. The logistics schedule management unit 301 may supply the logistics transfer schedule information for each logistics transfer period to the slave computer 200 in real time.

The transfer node management unit 302 may supply arrangement information of the first to n-th transfer modules 100(1) to 100(n) arranged and connected in the series structure, the parallel structure, or the mesh structure in which the series and parallel structures are combined, etc. to the slave computer 200.

The transfer node management unit 302 may check position information of transfer nodes at which at least three or more transfer modules are connected or branched according to the arrangement information of the first to n-th transfer modules 100(1) to 100(n), for example, arrangement position information of the transfer nodes, and supply the position information to the slave computer 200.

The transfer path management unit 303 may calculate transfer paths through which logistics such as the carrier 10 may be transferred according to the arrangement information of the first to n-th transfer modules 100(1) to 100(n) and supply the calculated transfer path information to the slave computer 200.

The transfer path management unit 303 may sequentially calculate transfer sections and transfer paths where logistics such as the carrier 10 may be transferred by checking the arrangement position information of the transfer nodes and reflecting the arrangement information of the first to n-th transfer modules 100(1) to 100(n) and the arrangement position information of the transfer nodes. For example, the transfer path management unit 303 may set the transfer section and transfer path from the first transfer module 100(1) to the tenth transfer module 100(10) through which logistics may be transferred by reflecting the arrangement information of the first to n-th transfer modules 100(1) to 100(n) and the arrangement position information of the transfer nodes. The transfer path management unit 303 may also set the transfer section and transfer path from the eleventh transfer module 100(11) to the n-th transfer module 100(n). The transfer path management unit 303 may supply information on the transfer sections and transfer paths through which logistics may be transferred to the slave computer 200.

The slave computer 200 may set the transfer path for logistics such as the carrier 10 by checking an arrangement structure of the first to n-th transfer modules 100(1) to 100(n) and controls the transfer operation of logistics for each of the first to n-th transfer modules 100(1) to 100(n) by checking the operation status for each of the first to n-th transfer modules 100(1) to 100(n).

Specifically, the slave computer 200, separately from the master facility server 300, may calculate the transfer paths through which logistics may be transferred according to the arrangement information of the first to n-th transfer modules 100(1) to 100(n). For example, the slave computer 200 may calculate the transfer paths through which logistics may be transferred by checking the arrangement information of the first to n-th transfer modules 100(1) to 100(n) received from the master facility server 300 in real time.

The slave computer 200 may sequentially calculate transfer sections and transfer paths where logistics such as the carrier 10 may be transferred by checking the arrangement position information of the transfer nodes and reflecting the arrangement information of the first to n-th transfer modules 100(1) to 100(n) and the arrangement position information of the transfer nodes. For example, the slave computer 200 may set a first transfer section and a first transfer path from a first transfer module at a starting position where logistics are received and seated, the first transfer module 100(1) to the last transfer module from which logistics are released, a tenth transfer module 100(10). In another example, the slave computer 200 may set an n-th transfer section and an n-th transfer path from a first transfer module at a different starting position, an eleventh transfer module 100(11) to the last transfer module, the n-th transfer module 100(n).

The slave computer 200 may receive and check status information of the transfer modules 100(1) to 100(n) included in the first to n-th transfer paths by sequentially transmitting first command functions including first instructions to the transfer modules 100(1) to 100(n) included in the respective transfer sections or transfer paths set in real time, for example, the first to n-th transfer sections or the first to n-th transfer paths.

The slave computer 200 may set driving characteristics such as the driving timing, logistics transfer direction, and logistics transfer velocity of each of the transfer modules 100(1) to 100(n) by transmitting second command functions including second instructions to the transfer modules 100(1) to 100(n) included in the first to n-th transfer paths according to the results of checking the status information of the transfer modules 100(1) to 100(n) included in the first to n-th transfer paths.

The slave computer 200 may set driving characteristics, such as the driving timing, change direction, direction change operation, direction change velocity, and logistics transfer velocity, of each of the transfer modules disposed at the transfer nodes by transmitting third command functions including third instructions to each of the transfer modules disposed at the transfer nodes among the transfer modules 100(1) to 100(n) included in the first to n-th transfer paths.

Referring to FIG. 2, the slave computer 200 may include a module control unit 210 and first, second, to n-th command function setting units 220, 230, and 250.

The module control unit 210 may sequentially calculate first to n-th transfer paths through which logistics may be transferred by reflecting the arrangement information of the first to n-th transfer modules 100(1) to 100(n) and the arrangement position information of the transfer nodes. The module control unit 210 may set driving characteristics for each of the first to n-th transfer modules 100(1) to 100(n) using at least one instruction among the first to n-th instructions.

The module control unit 210 may include a transfer path setting unit 211 and a command function selection unit 212.

The transfer path setting unit 211 may detect position information of transfer nodes at which at least three or more transfer modules are connected or branched, for example, arrangement position information of the transfer nodes by checking the arrangement information of the first to n-th transfer modules 100(1) to 100(n) in real time. The transfer path setting unit 211 may sequentially calculate first to n-th transfer sections and first to n-th transfer paths through which logistics such as the carrier 10 may be transferred by reflecting the arrangement information of the first to n-th transfer modules 100(1) to 100(n) and the arrangement position information of the transfer nodes.

For example, the transfer path setting unit 211 may set the transfer section and transfer path from the first transfer module 100(1) to the tenth transfer module 100(10) through which logistics may be transferred by reflecting the arrangement information of the first to n-th transfer modules 100(1) to 100(n) and the arrangement position information of the transfer nodes. The transfer path setting unit 211 may also set the transfer section and transfer path from the eleventh transfer module 100(11) to the n-th transfer module 100(n).

The command function selection unit 212 may receive and check status information of the transfer modules 100(1) to 100(n) included in the first to n-th transfer paths by sequentially transmitting first command functions including first instructions to the transfer modules 100(1) to 100(n) included in the first to n-th transfer sections or the first to n-th transfer paths.

The command function selection unit 212 may set driving characteristics such as the driving timing, logistics transfer direction, and logistics transfer velocity of each of the transfer modules 100(1) to 100(n) by transmitting second command functions including second instructions to the transfer modules 100(1) to 100(n) included in the first to n-th transfer paths according to the results of checking the status information of the transfer modules 100(1) to 100(n) included in the first to n-th transfer paths.

The command function selection unit 212 may set driving characteristics, such as the driving timing, change direction, direction change operation, direction change velocity, and logistics transfer velocity, of each of the transfer modules disposed at the transfer nodes by transmitting third command functions including third instructions to each of the transfer modules disposed at the transfer nodes among the transfer modules 100(1) to 100(n) included in the first to n-th transfer paths.

The first command function setting unit 220 may set and store first command functions including first instructions and supplies the first command functions to the module control unit 210. Here, the first command function setting unit 220 may store the first command functions including a status information check instruction requesting to transmit status information for each of the first to n-th transfer modules 100(1) to 100(n), a driving standby check instruction requesting to transmit driving standby status information for each of the first to n-th transfer modules 100(1) to 100(n), and a transfer check instruction requesting to transmit logistics transfer completion status information for each of the first to n-th transfer modules 100(1) to 100(n). The first command function setting unit 220 may transmit the first command functions to the module control unit 210 according to the selection of the module control unit 210. The first command function may be generated and set by a manager or a preset program and stored in the first command function setting unit 220.

The second command function setting unit 230 may set and store second command functions including second instructions and supplies the second command functions to the module control unit 210. Here, the second command function setting unit 230 may store the second command functions including a transfer direction setting instruction that sets the transfer direction of each of the first to n-th transfer modules 100(1) to 100(n) included in the first to n-th transfer paths, a transfer velocity and transfer position setting instruction of each of the first to n-th transfer modules 100(1) to 100(n), and a transfer start and end instruction of each of the first to n-th transfer modules 100(1) to 100(n). The second command function setting unit 230 may transmit the second command functions to the module control unit 210 according to the selection of the module control unit 210. The second command function may be generated and set by a manager or a preset program and stored in the second command function setting unit 230.

The n-th command function setting unit 250 may set and store third command functions including third instructions and supplies the third command functions to the module control unit 210. Specifically, the n-th command function setting unit 250 may store the third command functions including a direction change instruction, a change direction setting instruction, a direction change velocity setting instruction, a direction change and transfer position instruction, and a direction change start and end instruction for each of the transfer modules disposed at the transfer nodes among the transfer modules included in the first to n-th transfer paths. The n-th command function setting unit 250 may transmit the third command functions to the module control unit 210 according to the selection of the module control unit 210. The third command function may be generated and set by a manager or a preset program and stored in the n-th command function setting unit 250.

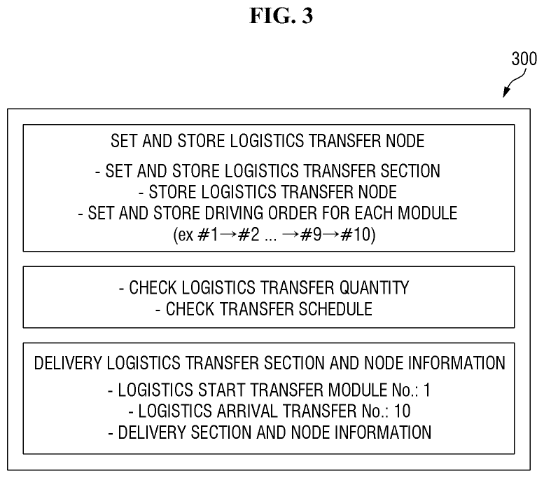

FIG. 3 is a block diagram illustrating a logic control processing of a master facility server illustrated in FIG. 2.

Referring to FIG. 3, the transfer path management unit 303 of the master facility server 300 may sequentially calculate transfer sections and transfer paths where logistics such as the carrier 10 may be transferred by checking the arrangement position information of the transfer nodes and reflecting the arrangement information of the first to n-th transfer modules 100(1) to 100(n) and the arrangement position information of the transfer nodes.

For example, the transfer path management unit 303 may set the transfer section and transfer path from the first transfer module 100(1) to the tenth transfer module 100(10) through which logistics may be transferred by reflecting the arrangement information of the first to n-th transfer modules 100(1) to 100(n) and the arrangement position information of the transfer nodes. The transfer path management unit 303 may also set the transfer section and transfer path from the eleventh transfer module 100(11) to the n-th transfer module 100(n). The transfer path management unit 303 may supply information on the transfer sections and transfer paths through which logistics may be transferred to the slave computer 200.

The logistics schedule management unit 301 of the master facility server 300 may supply logistics schedule information for each logistics transfer period, which is input or upgraded in real time by the manager, to the slave computer 200. The logistics schedule management unit 301 may check a logistics transfer quantity in real time and divide the logistics transfer periods according to the logistics transfer quantity. The logistics schedule management unit 301 may sequentially check the logistics transfer paths, for example, the number of logistics transfer paths, transfer position, and transfer distance, and distribute and set the logistics transfer schedule for each logistics transfer period.

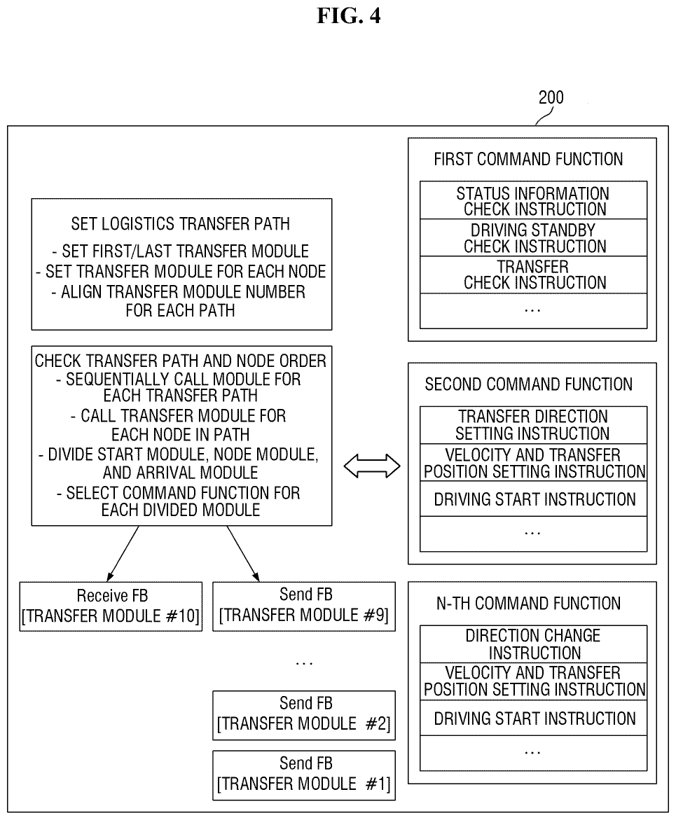

FIG. 4 is a block diagram illustrating a logic control processing of a slave computer illustrated in FIG. 2.

Referring to FIG. 4, the transfer path setting unit 211 of the slave computer 200 may detect position information of transfer nodes at which at least three or more transfer modules are connected or branched, for example, arrangement position information of the transfer nodes by checking the arrangement information of the first to n-th transfer modules 100(1) to 100(n) in real time. The transfer path setting unit 211 may sequentially calculate first to n-th transfer sections and first to n-th transfer paths through which logistics such as the carrier 10 may be transferred by reflecting the arrangement information of the first to n-th transfer modules 100(1) to 100(n) and the arrangement position information of the transfer nodes.

The command function selection unit 212 of the slave computer 200 may receive and check status information of the transfer modules 100(1) to 100(n) included in the first to n-th transfer paths by sequentially transmitting first command functions including first instructions to the transfer modules 100(1) to 100(n) included in the first to n-th transfer sections or the first to n-th transfer paths. The command function selection unit 212 may set driving characteristics such as the driving timing, logistics transfer direction, and logistics transfer velocity of each of the transfer modules 100(1) to 100(n) by transmitting second command functions including second instructions to the transfer modules 100(1) to 100(n) included in the first to n-th transfer paths according to the results of checking the status information of the transfer modules 100(1) to 100(n) included in the first to n-th transfer paths.

The first command functions of the first command function setting unit 220 may include a status information check instruction requesting to transmit status information for each of the first to n-th transfer modules 100(1) to 100(n), a driving standby check instruction requesting to transmit driving standby status information for each of the first to n-th transfer modules 100(1) to 100(n), and a transfer check instruction requesting to transmit logistics transfer completion status information for each of the first to n-th transfer modules 100(1) to 100(n).

The second command functions of the second command function setting unit 230 may include a transfer direction setting instruction that sets the transfer direction of each of the first to n-th transfer modules 100(1) to 100(n) included in the first to n-th transfer paths, a transfer velocity and transfer position setting instruction of each of the first to n-th transfer modules 100(1) to 100(n), and a transfer start and end instruction of each of the first to n-th transfer modules 100(1) to 100(n).

The third command functions of the n-th command function setting unit 250 may include a direction change instruction, a change direction setting instruction, a direction change velocity setting instruction, a direction change and transfer position instruction, and a direction change start and end instruction for each of the transfer modules disposed at the transfer nodes among the transfer modules included in the first to n-th transfer paths.

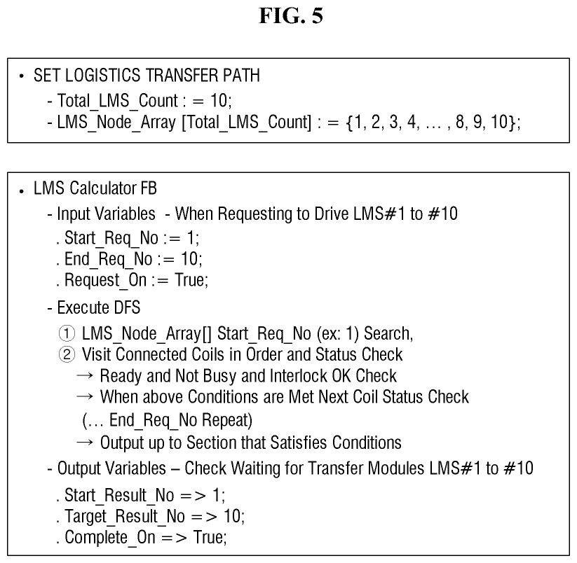

FIG. 5 is a block diagram illustrating an example of logic control program and function settings of the slave computer illustrated in FIG. 4.

Referring to FIG. 5, the transfer path setting unit 211 of the slave computer 200 may set the transfer section and transfer path from the first transfer module 100(1) to the tenth transfer module 100(10) through which logistics may be transferred by reflecting the arrangement information of the first to n-th transfer modules 100(1) to 100(n) and the arrangement position information of the transfer nodes. The transfer path setting unit 211 may also set the transfer section and transfer path from the eleventh transfer module 100(11) to the n-th transfer module 100(n). For example, the transfer path setting unit 211 may set and count the entire transfer path (e.g., first to tenth transfer paths) through which logistics may be transferred. Each of the transfer paths may include transfer nodes.

The transfer path setting unit 211 may set a first transfer section and a first transfer path from a first transfer module at a starting position where logistics are received and seated for each transfer path, for example, the first transfer module 100(1) to the last transfer module from which logistics are released, for example, a tenth transfer module 100(10). The transfer path setting unit 211 may also set an n-th transfer section and an n-th transfer path from a first transfer module at a different starting position, for example, an eleventh transfer module 100(11) to the last transfer module, for example, the n-th transfer module 100(n).

The command function selection unit 212 of the slave computer 200 may search for the transfer modules 100(1) to 100(n) included in the first to n-th transfer sections or the first to n-th transfer paths. The command function selection unit 212 may receive and check status information of the transfer modules 100(1) to 100(n) included in the first to n-th transfer paths by sequentially transmitting first command functions including first instructions to the transfer modules 100(1) to 100(n) included in the first to n-th transfer sections or the first to n-th transfer paths.

As described above, the first command functions may include the status information check instruction requesting to transmit status information for each of the first to n-th transfer modules 100(1) to 100(n), the driving standby check instruction requesting to transmit driving standby status information for each of the first to n-th transfer modules 100(1) to 100(n), and the transfer check instruction requesting to transmit logistics transfer completion status information for each of the first to n-th transfer modules 100(1) to 100(n).

In case that first command functions including the first instructions are input from the slave computer 200, the input/output communication unit 110 of each of the first to n-th transfer modules 100(1) to 100(n) transmits status information of each linear transfer core module 130 to the slave computer 200.

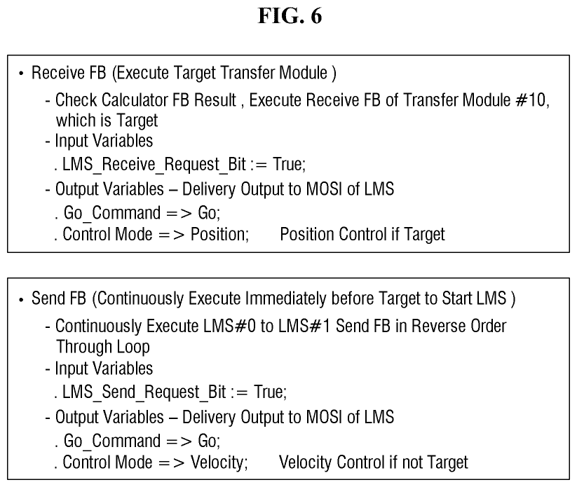

FIG. 6 is a block diagram illustrating an example of logic control program and function settings of the slave computer illustrated in FIG. 4.

Referring to FIG. 6, the command function selection unit 212 of the slave computer 200 may set driving characteristics such as the driving timing, logistics transfer direction, and logistics transfer velocity of each of the transfer modules 100(1) to 100(n) by transmitting second command functions including second instructions to the transfer modules 100(1) to 100(n) included in the first to n-th transfer paths according to the results of checking the status information of the transfer modules 100(1) to 100(n) included in the first to n-th transfer paths.

As described above, the second command functions may include a transfer direction setting instruction that sets the transfer direction of each of the first to n-th transfer modules 100(1) to 100(n) included in the first to n-th transfer paths, a transfer velocity and transfer position setting instruction of each of the first to n-th transfer modules 100(1) to 100(n), and a transfer start and end instruction of each of the first to n-th transfer modules 100(1) to 100(n).

The module driving control unit 120 of each of the first to n-th transfer modules 100(1) to 100(n) may set a logistics transfer and delivery position for each linear transfer core module 130 in response to the second instructions of the second command functions received through the input/output communication unit 110. The module driving control unit 120 may control driving characteristics such as a logistics transfer direction and a logistics transfer velocity for each linear transfer core module 130 in real time. Specifically, the module driving control unit 120 may repeatedly control the driving timing and driving velocity for each driving motor of the linear transfer core module 130 in response to the second instructions of the second command functions.

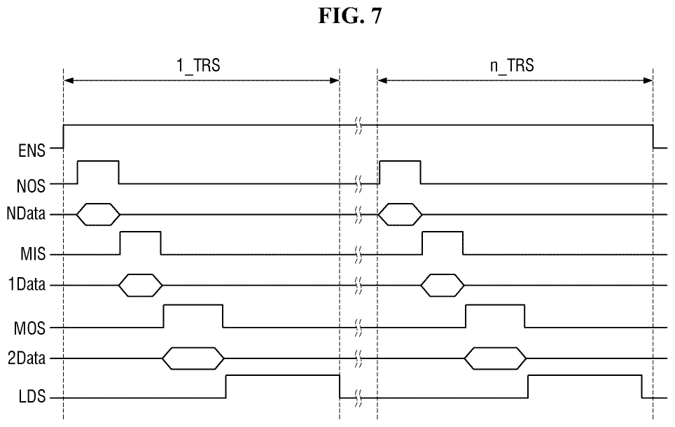

FIG. 7 is a waveform diagram illustrating the timing of transmission and reception of control signals and data transmitted and received between the slave computer and the transfer devices.

Referring to FIG. 7, the master facility server 300 may supply a logistics transfer enable signal ENS to the slave computer 200 and the first to n-th transfer modules 100(1) to 100(n) for each of the first to n-th logistics transfer periods 1_TRS to n_TRS.

The slave computer 200 and the first to n-th transfer modules 100(1) to 100(n) may be maintained in an enabled status in response to the logistics transfer enable signal ENS.

The master facility server 300 may transmit a first data transmission signal NOS to the slave computer 200 to switch the slave computer 200 to a data reception status. The master facility server 300 may supply logistics schedule information NData to the slave computer 200 for each of the first to n-th logistics transfer periods 1_TRS to n_TRS.

The command function selection unit 212 of the slave computer 200 may search for the transfer modules 100(1) to 100(n) included in the first to n-th transfer sections or the first to n-th transfer paths. The command function selection unit 212 may transmit second data transmission signal MIS to the first to n-th transfer modules 100(1) to 100(n). During the transmission period of the second data transmission signal MIS, the command function selection unit 212 may sequentially transmit first command functions 1Data including the first instructions to the transfer modules 100(1) to 100(n) included in the first to n-th transfer paths.

In case that first command functions including the first instructions are input from the slave computer 200, the input/output communication unit 110 of each of the first to n-th transfer modules 100(1) to 100(n) transmits status information of each linear transfer core module 130 to the slave computer 200. The input/output communication unit 110 may receive and check status information of the transfer modules 100(1) to 100(n) included in the first to n-th transfer paths.

The command function selection unit 212 of the slave computer 200 may transmit a third data transmission signal MOS to the first to n-th transfer modules 100(1) to 100(n) according to the check result of the stage information of the transfer modules 100(1) to 100(n) included in the first to n-th transfer paths. During the transmission period of the third data transmission signal MOS, the command function selection unit 212 may set driving characteristics such as driving timing, logistics transfer direction, and logistics transfer velocity of each of the transfer modules 100(1) to 100(n) by transmitting second command functions 2Data including second instructions to the transfer modules 100(1) to 100(n) included in the first to n-th transfer paths.

The command function selection unit 212 of the slave computer 200 may additionally supply a logistics transfer operation signal LDS to the transfer modules 100(1) to 100(n) included in the first to n-th transfer paths.

During the supply period of the logistics transfer operation signal LDS, the module driving control unit 120 of each of the first to n-th transfer modules 100(1) to 100(n) may set a logistics transfer and delivery position for each linear transfer core module 130 in response to the second instructions of the second command functions 2Data received through the input/output communication unit 110. The module driving control unit 120 may control driving characteristics such as a logistics transfer direction and a logistics transfer velocity for each linear transfer core module 130 in real time. Specifically, the module driving control unit 120 may repeatedly control the driving timing and driving velocity for each driving motor of the linear transfer core module 130 in response to the second instructions of the second command functions 2Data.

According to the embodiments described above, the operation of the transfer devices may be readily controlled using the computer or slave control board by selecting preset control functions or programs according to the logistics movement route or transfer section and controlling the transfer devices with the selected control functions or programs.

Logistics transfer efficiency and management efficiency of manufacturing devices may be improved by readily controlling the transfer operation of transfer devices according to the logistics transfer schedule, transfer node, and transfer section even if the transfer devices are added or the logistics transfer routes of the transfer devices are changed.

In concluding the detailed description, those skilled in the art will appreciate that many variations and modifications may be made to the embodiments without substantially departing from the principles and spirit and scope of the disclosure. Therefore, the disclosed embodiments of the disclosure are used in a generic and descriptive sense only and not for purposes of limitation.

The above description is an example of technical features of the disclosure, and those skilled in the art to which the disclosure pertains will be able to make various modifications and variations. Thus, the embodiments of the disclosure described above may be implemented separately or in combination with each other.

The embodiments disclosed in the disclosure are intended not to limit the technical spirit of the disclosure but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A transfer device control system comprising:
a linear transfer device including first to n-th transfer modules of a linear motion guide type, where n is a positive integer;
a slave computer setting a transfer path for carriers or logistics by checking an arrangement structure of the first to n-th transfer modules and controlling a transfer operation of the logistics for each of the first to n-th transfer modules in real time by checking an operation status of each of the first to n-th transfer modules; and
a master facility server supplying arrangement information of the first to n-th transfer modules and logistics schedule information for each logistics transfer period to the slave computer.

2. The transfer device control system of claim 1, wherein the master facility server includes:
a logistics schedule management unit supplying the logistics schedule information for each logistics transfer period input or upgraded in real time by a manager to the slave computer; and
a transfer node management unit supplying the arrangement information of the first to n-th transfer modules arranged and connected in a series structure, a parallel structure, or a mesh structure in which serial and parallel structures are combined, to the slave computer.

3. The transfer device control system of claim 2, wherein
the master facility server further includes a transfer path management unit calculating transfer paths through which the logistics are transferred according to the arrangement information of the first to n-th transfer modules and supplying information on the calculated transfer paths to the slave computer, and
the transfer node management unit checks arrangement position information of transfer nodes where at least three or more transfer modules are connected or branched according to the arrangement information of the first to n-th transfer modules and supplies the arrangement position information to the slave computer.

4. The transfer device control system of claim 2, wherein the slave computer includes:
a module control unit sequentially calculating first to n-th transfer paths through which the logistics are transferred by reflecting the arrangement information of the first to n-th transfer modules and arrangement position information of transfer nodes and setting driving characteristics of each of the first to n-th transfer modules using at least one command function among first to n-th command functions;
a first command function setting unit setting and storing first command functions including first instructions and supplying the first command functions to the module control unit;
a second command function setting unit setting and storing second command functions including second instructions and supplying the second command functions to the module control unit; and
an n-th command function setting unit setting and storing third command functions including third instructions and supplying the third command functions to the module control unit.

5. The transfer device control system of claim 4, wherein the module control unit includes:
a transfer path setting unit detecting the arrangement position information of the transfer nodes where at least three or more transfer modules are connected or branched by checking the arrangement information of the first to n-th transfer modules in real time and sequentially calculating first to n-th transfer sections and first to n-th transfer paths through which the logistics are transferred by reflecting the arrangement information of the first to n-th transfer modules and the arrangement position information of the transfer nodes; and
a command function selection unit receiving and checking status information of the first to n-th transfer modules included in the first to n-th transfer paths by sequentially transmitting the first command functions to the first to n-th transfer modules included in the first to n-th transfer paths and setting driving characteristics including driving timing, logistics transfer direction, and logistics transfer velocity of each of the first to n-th transfer modules included in the first to n-th transfer paths by sequentially transmitting the second command functions to the first to n-th transfer modules included in the first to n-th transfer paths.

6. The transfer device control system of claim 5, wherein the command function selection unit sets driving characteristics including the driving timing, change direction, direction change operation, direction change velocity, and the logistics transfer velocity of each of the first to n-th transfer modules disposed at the transfer nodes by transmitting the third command functions to each of the first to n-th transfer modules disposed at the transfer nodes among the first to n-th transfer modules included in the first to n-th transfer paths.

7. The transfer device control system of claim 5, wherein the first command function setting unit stores first command functions including a status information check instruction requesting to transmit status information for each of the first to n-th transfer modules, a driving standby check instruction requesting to transmit driving standby status information for each of the first to n-th transfer modules, and a transfer check instruction requesting to transmit logistics transfer completion status information for each of the first to n-th transfer modules and transmits the first command functions to the module control unit according to selection of the module control unit.

8. The transfer device control system of claim 5, wherein the second command function setting unit stores second command functions including a transfer direction setting instruction that sets a transfer direction of each of the first to n-th transfer modules included in the first to n-th transfer paths, a transfer velocity and transfer position setting instruction of each of the first to n-th transfer modules, and a transfer start and end instruction of each of the first to n-th transfer modules and transmits the second command functions to the module control unit according to selection of the module control unit.

9. The transfer device control system of claim 5, wherein the n-th command function setting unit stores third command functions including a direction change instruction, a change direction setting instruction, a direction change velocity setting instruction, a direction change and transfer position instruction, and a direction change start and end instruction for each of the transfer modules disposed at the transfer nodes among the transfer modules included in the first to n-th transfer paths and transmits the third command functions to the module control unit according to selection of the module control unit.

10. The transfer device control system of claim 2, wherein each of the first to n-th transfer modules includes:
at least one linear transfer core module transferring and delivering the carriers or the logistics along a preset path according to an arrangement direction;
an input/output communication unit transmitting status information of the at least one linear transfer core module to the slave computer in response to first command functions input from the slave computer, receiving second command functions input from the slave computer, and storing and sharing the received second command functions; and
a module driving control unit setting logistics transfer and delivery positions for each of the at least one linear transfer core module in response to the second command functions including second instructions and controlling driving characteristics including logistics transfer direction and logistics transfer velocity in real time.

11. A transfer device control system comprising:
a linear transfer device including first to n-th transfer modules of a linear motion guide type, where n is a positive integer;
a slave computer setting a transfer path for carriers or logistics by checking an arrangement structure of the first to n-th transfer modules, and controlling a transfer operation of the logistics for each of the first to n-th transfer modules in real time by checking an operation status of each of the first to n-th transfer modules; and
a master facility server supplying arrangement information of the first to n-th transfer modules and logistics schedule information for each logistics transfer period to the slave computer,
wherein the slave computer sequentially calculates transfer paths through which the logistics are transferred according to the arrangement information of the first to n-th transfer modules and controls a logistics transfer operation of the first to n-th transfer modules for each of the transfer paths.

12. The transfer device control system of claim 11, wherein the master facility server includes:
a logistics schedule management unit supplying the logistics schedule information for each logistics transfer period input or upgraded in real time by a manager to the slave computer; and
a transfer node management unit supplying the arrangement information of the first to n-th transfer modules arranged and connected in a series structure, a parallel structure, or a mesh structure in which serial and parallel structures are combined, to the slave computer.

13. The transfer device control system of claim 12, wherein the slave computer includes:
a module control unit sequentially calculating first to n-th transfer paths through which the logistics are transferred by reflecting the arrangement information of the first to n-th transfer modules and arrangement position information of transfer nodes and setting driving characteristics of each of the first to n-th transfer modules using at least one command function among first to n-th command functions;
a first command function setting unit setting and storing first command functions including first instructions and supplying the first command functions to the module control unit;
a second command function setting unit setting and storing second command functions including second instructions and supplying the second command functions to the module control unit; and
an n-th command function setting unit setting and storing third command functions including third instructions and supplying the third command functions to the module control unit.

14. The transfer device control system of claim 13, wherein the module control unit includes:
a transfer path setting unit detecting arrangement position information of the transfer nodes where at least three or more transfer modules are connected or branched by checking the arrangement information of the first to n-th transfer modules in real time and sequentially calculating first to n-th transfer sections and first to n-th transfer paths through which the logistics are transferred by reflecting the arrangement information of the first to n-th transfer modules and the arrangement position information of the transfer nodes; and
a command function selection unit receiving and checking status information of the first to n-th transfer modules included in the first to n-th transfer paths by sequentially transmitting the first command functions to the first to n-th transfer modules included in the first to n-th transfer paths, and setting driving characteristics including driving timing, logistics transfer direction, and logistics transfer velocity of each of the first to n-th transfer modules included in the first to n-th transfer paths by sequentially transmitting the second command functions to the first to n-th transfer modules included in the first to n-th transfer paths.

15. The transfer device control system of claim 12, wherein each of the first to n-th transfer modules includes:
at least one linear transfer core module transferring and delivering the carriers or the logistics along a preset path according to an arrangement direction;
an input/output communication unit transmitting status information of the at least one linear transfer core module to the slave computer in response to first command functions input from the slave computer, receiving second command functions input from the slave computer, and storing and sharing the received second command functions; and
a module driving control unit setting logistics transfer and delivery positions for each of the at least one linear transfer core module in response to the second command functions including second instructions and controlling driving characteristics including logistics transfer direction and logistics transfer velocity in real time.
